(19) United States
(12) Patent Application Publication
(10) Pub. No.: US 2015/0247620 A1
(43) Pub. Date: Sep. 3, 2015

(54) Outdoor Lighting System

(71) Applicant: Evans Edward Thompson, III, San Francisco, CA (US)

(72) Inventor: Evans Edward Thompson, III, San Francisco, CA (US)

(21) Appl. No.: 14/632,714

(22) Filed: Feb. 26, 2015

Related U.S. Application Data
(60) Provisional application No. 61/946,131, filed on Feb. 28, 2014.

(51) Int. Cl. F21V 11/16; F21K 99/00; F21V 23/00

(52) U.S. Cl. CPC F21V 11/16; F21V 23/008; F21K 9/50; F21Y 2105/001

(57) ABSTRACT

A lighting fixture can comprise a rim or raised edge that extends peripherally around a recessed area. Light emitting diodes can be mounted in the recessed area and oriented to emit light out of the recessed area, towards an area to be illuminated by the lighting fixture. The lighting fixture can be mounted above the area, which may be outdoors, for example. A cavity can be formed inside the rim or raised edge. Circuitry for the light emitting diodes can be disposed in the cavity, so that the rim or raised edge encloses or houses the circuitry. The circuitry can comprise a light emitting diode driver, for example. The rim or raised edge can block emission of unwanted light, for example to function as a light pollution shield.

### CROSS REFERENCE TO RELATED APPLICATIONS

This application claims priority to U.S. Provisional Patent Application No. 61/946,131 filed Feb. 28, 2014 in the name of Evans Edward Thompson and entitled “Outdoor Lighting System,” the entire contents of which are hereby incorporated herein by reference.

### STATEMENT REGARDING FEDERALLY SPONSORED RESEARCH OR DEVELOPMENT

This invention was made with government support under Contract Number DE_EE0006260 awarded by the United States Department of Energy. The government has certain rights in the invention

### TECHNICAL FIELD

Embodiments of the technology relate generally to lighting solutions, and more particularly to an outdoor luminaire that incorporates a light pollution shield.

### BACKGROUND

Light emitting diodes (LEDs) offer substantial potential benefit for illumination applications associated with energy efficiency and compact size. However, to realize the full potential of the benefits offered by light emitting diodes, new technologies are needed.

For example, improvements in compact housings are needed. Improvements are needed for outdoor luminaires. Improvements are also needed for luminaire housings that can provide better environmental protection for electronic components and circuitry that power light emitting diodes. Improvements are further needed for luminaires that can control emission of light in unwanted directions, for example to avoid skyward light emissions that may result in light pollution. A capability addressing one or more such needs, or some other related deficiency in the art, would support improved illumination systems and more widespread utilization of light emitting diodes in lighting applications.

### SUMMARY

A lighting system can provide illumination, for example as an outdoor luminaire. The lighting system can emit light from a recessed area, for example using light emitting diodes mounted in the recessed area. A rim can extend peripherally about the recessed area. A cavity can be formed within the rim, which may comprise a raised edge.

Circuitry for the light emitting diodes can be located in the cavity, so that the rim houses or encloses the circuitry. The rim or raised edge can block emission of unwanted light, for example to function as a light pollution shield.

The foregoing discussion of lighting systems is for illustrative purposes only. Various aspects of the present technology may be more clearly understood and appreciated from a review of the following text and by reference to the associated drawings and the claims that follow. Other aspects, systems, methods, features, advantages, and objects of the present technology will become apparent to one with skill in the art upon examination of the following drawings and text. It is intended that all such aspects, systems, methods, features, advantages, and objects are to be included within this description and covered by this application and by the appended claims of the application.

### BRIEF DESCRIPTION OF THE DRAWINGS

FIG. 1 illustrates an outdoor luminaire providing illumination above a surface according to some example embodiments of the present technology.

FIGS. 2A, 2B, and 2C (collectively FIG. 2) illustrate, in cross-sectional views, an outdoor luminaire according to some example embodiments of the present technology.

FIG. 3 illustrates a perspective view of an outdoor luminaire, with the housing illustrated transparent to facilitate visualization of internal elements, according to some example embodiments of the present technology.

FIG. 4 illustrates a perspective view of an outdoor luminaire according to some example embodiments of the present technology.

The drawings illustrate only example embodiments and are therefore not to be considered limiting of the embodiments described, as other equally effective embodiments are within the scope and spirit of this disclosure. The elements and features shown in the drawings are not necessarily drawn to scale, emphasis instead being placed upon clearly illustrating principles of the embodiments. Additionally, certain dimensions or positionings may be exaggerated to help visually convey certain principles. In the drawings, similar reference numerals among different figures designate like or corresponding, but not necessarily identical, elements.

### DESCRIPTION OF EXAMPLE EMBODIMENTS

A lighting fixture can comprise a recessed area in which light emitting diodes are mounted. So mounted, the light emitting diodes can be oriented to emit light towards a space to be illuminated once the fixture is installed in a typical operating configuration. While not limited to outdoor applications, in some embodiments, the lighting fixture is mounted overhead as an outdoor luminaire and emits light towards the ground. A portion of emitted light can be emitted in directions other than towards the ground, including horizontally and skyward. The light traveling horizontally and skyward can be unwanted, for example producing light pollution if allowed to travel in that direction after exiting the fixture.

The outdoor lighting fixture can comprise a rim or raised edge that extends peripherally around the area in which the light emitting diodes are mounted, so that the light emitting diodes are in a recessed area. The rim or raised edge can be opaque, to form a light pollution shield. The light pollution shield can block any unwanted light that may be travelling horizontally or skyward before such light exits the fixture. The rim or raised area can comprise a cavity in which an electrical system is mounted. The electrical system can comprise a driver for the light emitting diodes. The cavity can extend lengthwise along the path of the rim or raised edge, for example at least partially beside the area in which the light emitting diodes are mounted.

The present technology can be embodied in many different forms and should not be construed as limited to the embodiments set forth herein; rather, these embodiments are provided so that this disclosure will be thorough and complete, and will fully convey the scope of the technology to those having ordinary skill in the art. Furthermore, all “examples,” “embodiments,” “example embodiments,” or “exemplary embodiments” given herein are intended to be non-limiting and among others supported by representations of the present technology.

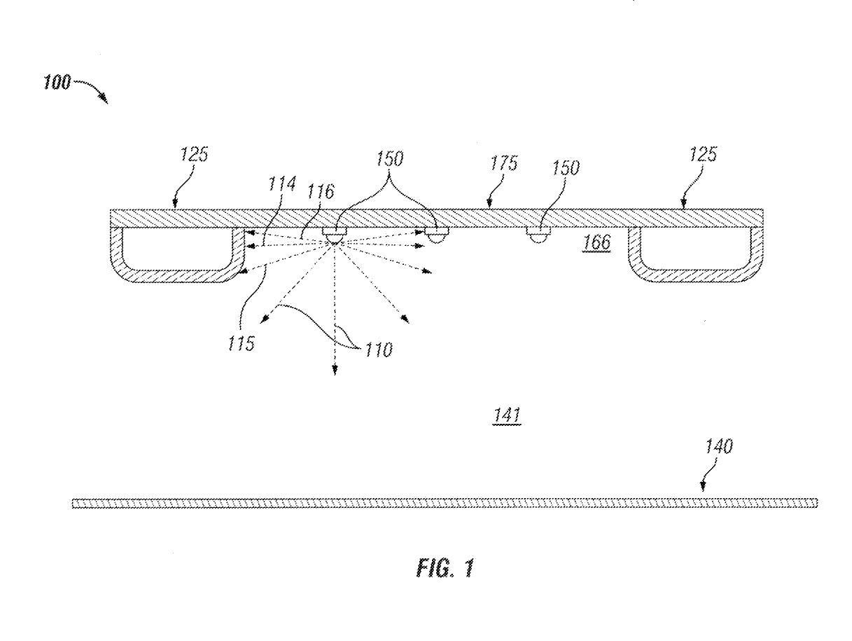

Outdoor lighting systems will now be described more fully with reference to FIGS. 1-4, which describe representative embodiments of the present technology and illustrate an outdoor lighting system, in particular an example luminaire for overhead lighting.

Turning now to FIG. 1, this figure illustrates an outdoor luminaire 175 providing illumination above a surface 140 according to some example embodiments of the present technology. The outdoor luminaire 175 can be mounted to a pole or a ceiling or some other appropriate structure or member, for example. The surface 140 may be a parking lot, a parking deck floor, a street, a path, a sidewalk, a field, a floor of a room, or other appropriate natural or artificial surface. Accordingly, the outdoor luminaire 175 can provide illumination for an area 141 and an associated surface 140. In some example embodiments, the outdoor luminaire 175 may comprise an overhead streetlight.

The example outdoor luminaire 100 includes light emitting diodes (“LEDs”) 150 that are mounted to a substrate 175 in an orientation to illuminate the area 141 and the surface 140. In an example embodiment, the substrate 175 comprises a circuit board or other sheet of material.

The light produced by the light emitting diodes 150 is represented in FIG. 1 by rays 110, 114, 115, 116. The rays 110 represent the majority of the emitting light, which is directed into the area 141 and towards the surface 140. The ray 115 represents light that is below horizontal but headed in a direction other than where illumination is desired. The ray 114 represents light that is headed horizontal. The ray 116 represents light that is headed above horizontal.

The rays 114 and 116 can comprise stray light, including light that may bounce around or be inadvertently scattered within the outdoor luminaire 100, for example. The rays 114 and the rays 116 may contribute to light pollution if allowed to exit the outdoor luminaire 100 in the indicated directions.

The term “light pollution,” as used herein, generally refers to artificial light that is excessive, misdirected, obtrusive, or otherwise unwanted. Light pollution can comprise photopollution or luminous pollution, for example. Light pollution can comprise light that competes with natural light from stars in the night sky, interferes with astronomical instruments, disturbs animals or an ecosystem, or annoys or discomforts people, for example.

The outdoor luminaire 100 comprises a rim 125 that occludes or blocks the rays 114, 115, and 116 and thus functions as and comprises a light pollution shield. The term “light pollution shield,” as used herein, generally refers to something, such as a device or portion of a device, that reduces light pollution.

In some embodiments, the rim 125 occludes light that is headed skyward and could interfere with operation of an astronomical telescope. In some embodiments, the rim 125 occludes light that is headed outside the area 141 where illumination is desired, thereby avoiding stray illumination in an outdoor application. In some embodiments, the rim 125 occludes light that is headed beyond an area 141 where indoor illumination is desired, for example avoiding unwanted illumination in an indoor application.

The rim 125, which can be characterized as a raised edge in the illustrated embodiment, forms a recessed area 166 in which the light emitting diodes 150 are mounted. As a light pollution shield, the rim 125 extends about the periphery of the light emitting diodes 150. The rim 125 prevents the emitted light from traveling skyward, thus suppressing light pollution. Thus, the rim 125 occludes rays of light oriented in an unintended direction, for example skyward. In some embodiments, the rim 125 is a unitary element. In other embodiments, the rim 125 comprises multiple components. As discussed in further detail below, the rim 125 has an internal cavity that houses electrical circuitry for the outdoor luminaire 100.

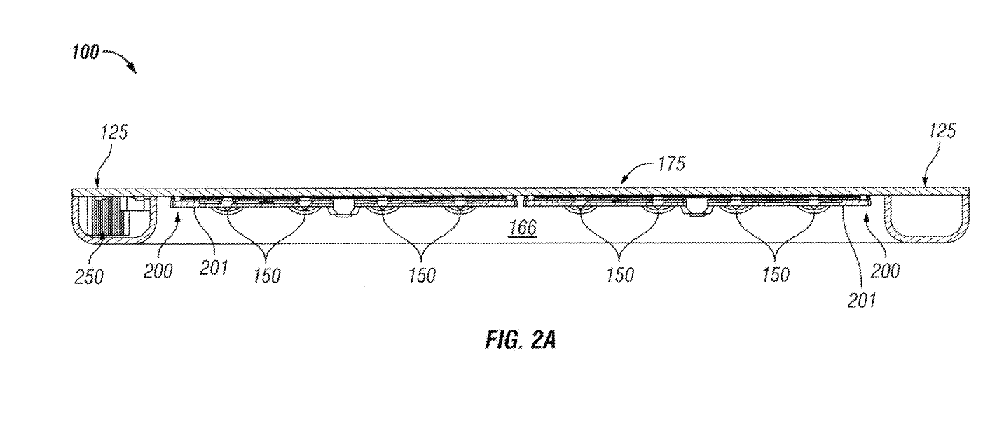

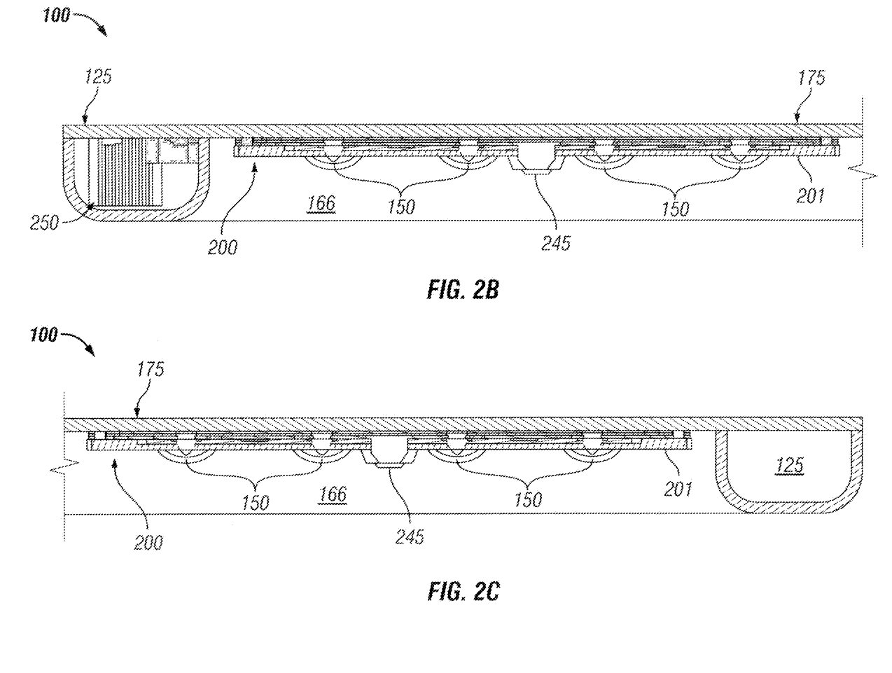

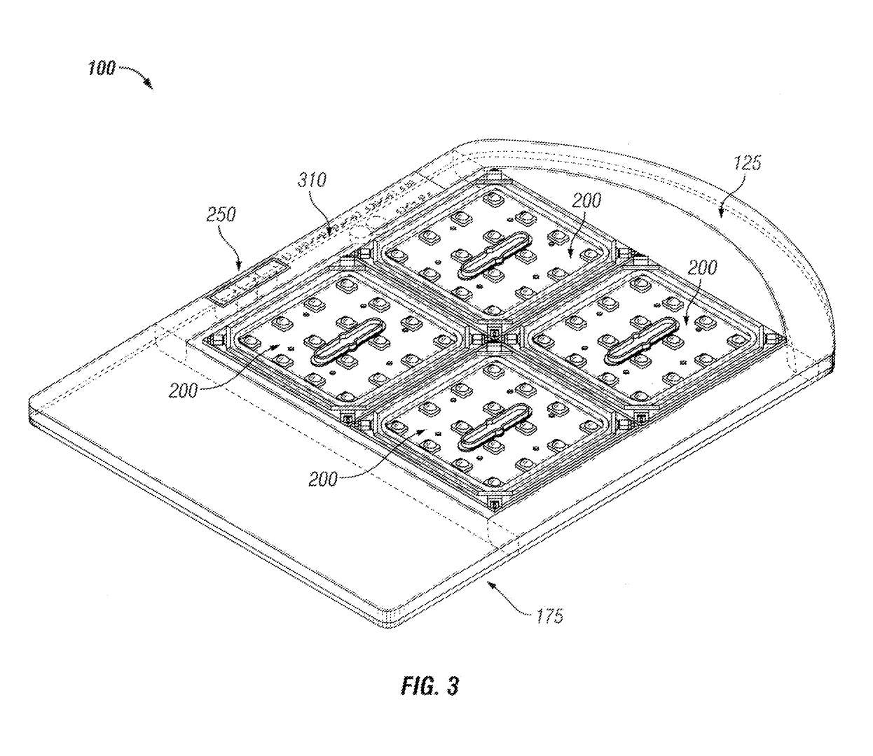

Turning now FIG. 2, three cross-sectional views of the outdoor luminaire 125 are illustrated according to some example embodiments of the present technology. FIG. 2A illustrates a full cross sectional view. FIG. 2B provides a magnified cross sectional view of the portion of the outdoor luminaire 100 that is on the left in the view of FIG. 2A. FIG. 2C provides a magnified cross sectional view of the right hand portion of the outdoor luminaire 100.

The example outdoor luminaire 100 illustrated in FIG. 2 corresponds to the outdoor luminaire 100 that is illustrated in FIG. 1 and described above. In the embodiment of FIG. 2, additional detail is illustrated, including two light emitting diode arrays 200 rather than the discrete light emitting diodes 150 shown in FIG. 1 in example form.

Each of the light emitting diode arrays 200 comprises light emitting diodes 150 that are covered by an optic 201. The example optic 201 comprises an array of optical features formed in a single piece of optical material. In the illustrated embodiment, each optical feature comprises a cavity that faces the associated light emitting diode 150 and an adjacent optical surface that faces away from the associated light emitting diodes 150.

In the illustrated embodiment, the optical surface that faces away from the light emitting diodes is convex and refractive. Other embodiments may utilize other optical forms, including reflective optics, for example. As illustrated, the optic 201 directs the light that is emitted from the light emitting diodes 150 towards the surface 140 and the area 141 to be illuminated (see FIG. 1). Each optic 201 is attached to the substrate 175 of the outdoor lighting fixture 100 via a fastener 245.

In various example embodiments, the fasteners 245 can comprise one or more clips, screws, rivets, adhesives, snaps, or other appropriate fastening technology, without limitation. In some embodiments, the optic 201 and the fastener 245 can seal the light emitting diodes 150 to protect against ingress of moisture, dust, debris, or other environmental contamination. The optic 201 can thus provide the light emitting diodes 150 with a moisture or environmental seal. Accordingly, the outdoor luminaire 100 can comprise weatherproof seals formed from gaskets or other appropriate sealing materials, for example.

In the illustrated embodiment, the rim 125 is hollow to provide a cavity in which a light emitting diode driver 250 and associated wiring and circuitry is mounted. The driver 250 can receive electricity from external power and convert the electricity into a form suitable for driving the light emitting diodes 150. Circuitry housed in the cavity of the rim 125 may include one or more circuit boards, resistors, electrical traces, wires, capacitors, inductors, microprocessors, integrated circuits, amplifiers, transformers, drivers, transistors, connectors, and/or other appropriate electrical components and systems, to mention a few representative examples without limitation.

The rim 125 can be opaque to block, reflect, or redirect incident light, such as the representative rays 114, 115, 116 illustrated in FIG. 1. In some example embodiments, the rim 125 is formed from one or more channels or tubes of aluminum or other metal. In some example embodiments, the rim 125 is formed from back plastic or fiberglass. In some embodiments, the rim 125 is formed from a channel of optical plastic material that is loaded or filled with a light-scattering agent to provide opacity. In some embodiments, the rim 125 comprises a lower section and an upper section that meet to provide an enclosed space that is environmentally sealed.

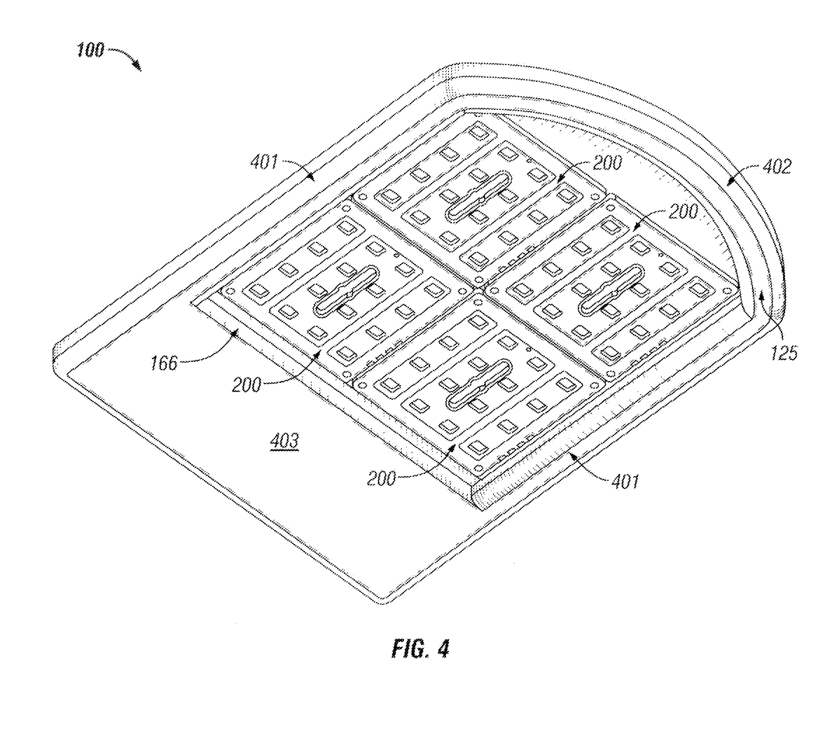

Turning now to FIGS. 3 and 4, these figures illustrate perspective views of the outdoor luminaire 100 as illustrated in FIG. 2 and discussed above according to some example embodiments of the present technology. In FIG. 3, the housing is illustrated transparent (artificially) to facilitate visualization of representative internal elements. In FIG. 4, the housing is depicted opaque as would be typical of an embodiment deployed in an application.

The views of FIGS. 3 and 4 illustrate four light emitting diode arrays 200 that are mounted to the substrate. Each of the light emitting diode arrays 200 can comprise a unit or a module. In some embodiments, fewer or more light emitting diode arrays 200 can be utilized. In various embodiments, the light emitting diode arrays 200 can comprise diodes arranged in lines, circles, honeycomb patterns, or other geometric form or distribution as may be suitable for various applications. In some embodiments, the outdoor luminaire 100 incorporates one or more chip-on-board (“CoB”) light emitting diodes in the recessed area 166.

In the illustrated embodiment, the rim 125 forms a perimeter around the recessed area 166. The rim 125 includes a curved section 402, two narrow straight sections 401, and a wide straight section 403.

As shown in FIG. 3, the diver 250 is located in a straight section 401 of the rim 125 and includes a circuit board 310. In some embodiments, the driver 250 is located in the curved section 402 of the rim 125, rather than in a straight section 401. In some embodiments, the driver 250 or other electrical systems of the outdoor luminaire 100 can be located in the wide straight section 403 of the rim. In some embodiments, the driver 250 (or other wiring or circuitry) extends across multiple sides of the rim 125. For example a portion of the driver circuitry can be in a straight section 401 with another portion in the curved section 402.

In some embodiments, locating the driver 250 in a cavity of the rim 125 enhances thermal separation or isolation between the light emitting diode arrays 200 and the driver electronics. Heat generated by operation of the light emitting diode arrays 200 can thus be diverted or directed away from the driver 250. Accordingly, the driver 250 can be operated at a low temperature relative to an elevated operating temperature of the light emitting diode arrays 200.

In some embodiments, the outdoor luminaire 100 comprises one or more heat sinks for thermal management. The housing of the outdoor luminaire 100 may function as a heat sink, for example. In some embodiments, the housing incorporates fins or a patterned surface that helps dissipate heat. In some embodiments, the outdoor luminaire 100 incorporates one or more heat sinks that are mounted to the housing, and such heat sinks can comprise fins, for example.

Technology for lighting and for controlling stray light having a propensity to contribute to light pollution has been described. From the description, it will be appreciated that embodiments of the present technology overcome limitations of the prior art. Those skilled in the art will appreciate that the present technology is not limited to any specifically discussed application or implementation and that the embodiments described herein are illustrative and not restrictive. From the description of the example embodiments, equivalents of the elements shown therein will suggest themselves to those skilled in the art, and ways of constructing other embodiments of the present technology will appear to practitioners of the art.

What is claimed is:

1. A lighting fixture comprising:
a rim forming a recessed area, the rim substantially opaque and comprising a rim cavity;
a substrate disposed in the recessed area;
a plurality of light emitting diodes disposed along the substrate and oriented to emit light out of the recessed area; and
an electrical supply for the plurality of light emitting diodes, the electrical supply disposed in the rim cavity.

2. The lighting fixture of claim 1, wherein the rim is operative to reduce light pollution by blocking light rays oriented to travel skyward.

3. The lighting fixture of claim 1, wherein the rim is operative to suppress light pollution by blocking light rays traveling parallel to the substrate.

4. The lighting fixture of claim 1, wherein the electrical supply comprises a circuit board that is disposed in the rim cavity.

5. The lighting fixture of claim 1, wherein the electrical supply comprises a light emitting diode driver, and
wherein the lighting fixture is configured to provide overhead illumination.

6. The lighting fixture of claim 1, wherein the plurality of light emitting diodes comprise a plurality of light emitting diode arrays oriented to emit light out of the recessed area from above an outdoor area to be illuminated.

7. The lighting fixture of claim 6, wherein each light emitting diode array is covered by a respective optic.

8. The lighting fixture of claim 7, wherein the respective optic comprises a respective lens for each light emitting diode in the light emitting diode array.

9. An exterior lighting fixture comprising:
a frame that is configured for mounting above an area to be illuminated and that comprises:
a surface;
a raised edge extending peripherally around the surface; and
a cavity disposed inside the raised edge;
a light emitting diode array disposed at the surface and oriented for illuminating the area; and
a driver disposed in the cavity and electrically coupled to the light emitting diode array.

10. The exterior lighting fixture of claim 9, wherein the cavity extends along the raised edge and provides a weatherproof housing for the driver.

11. The exterior lighting fixture of claim 9, wherein the cavity extends at least partially around the surface.

12. The exterior lighting fixture of claim 9, wherein the raised edge is opaque,
wherein the light emitting diode array is one of a plurality of light emitting diode arrays mounted to the surface, and
wherein the driver is wired to supply electricity to each light emitting diode array in the plurality of light emitting diode arrays mounted to the surface.

13. The exterior lighting fixture of claim 9, wherein the raised edge comprises a light pollution shield.

14. The exterior lighting fixture of claim 9, wherein the raised edge is configured to block horizontally oriented light rays produced by the light emitting diode array,
wherein the light emitting diode array disposed at the surface is one of a plurality of light emitting diode arrays disposed at the surface,
wherein each light emitting diode array in the plurality of light emitting diode arrays has an associated optic, and
wherein each optic comprises a plurality of refractors, at least one for each light emitting diode in the associated light emitting diode array.

15. An exterior lighting fixture comprising:
one or more light emitting diodes mounted to a substrate;
a light pollution shield forming a perimeter around the substrate;
a cavity disposed in the light pollution shield; and
a driver disposed in the cavity and electrically coupled to the one or more light emitting diodes.

16. The exterior lighting fixture of claim 15, wherein a plurality of light emitting diode arrays are mounted to the substrate,
wherein the plurality of light emitting diodes comprises the one or more light emitting diodes,
wherein an optic is associated with each light emitting diode array,
wherein each associated optic comprises an array of refractive elements, one for each light emitting diode in the associated light emitting diode array, and
wherein the driver is wired to supply the plurality of light emitting diode arrays with electricity.

17. The exterior lighting fixture of claim 15, wherein the cavity extends along the perimeter,
wherein a plurality of light emitting diode arrays are mounted to the substrate, one of the light emitting diode arrays comprising said one or more light emitting diodes,
wherein each of the light emitting diode arrays is modular, and
wherein each light emitting diode array has an associated optic that comprises a corresponding lens array.

18. The exterior lighting fixture of claim 15, wherein the driver is mounted to a circuit board that is disposed in the cavity.

19. The exterior lighting fixture of claim 15, wherein the exterior lighting fixture comprises an overhead streetlight.

20. The exterior lighting fixture of claim 15, wherein the perimeter comprises two sides that each extends substantially straight and another side that extends along a curve.
